(19) United States
(12) Patent Application Publication
(10) Pub. No.: US 2018/0176528 A1
(43) Pub. Date: Jun. 21, 2018

(54) LIGHT LOCUS GENERATION FOR AUTOMATIC WHITE BALANCE

(71) Applicant: MediaTek Inc., Hsinchu (TW)

(72) Inventors: Ying-Yi Li, Taipei (TW); Hsien-Che Lee, Pleasanton, CA (US)

(21) Appl. No.: 15/786,866

(22) Filed: Oct. 18, 2017

Related U.S. Application Data
(63) Continuation-in-part of application No. 15/425,113, filed on Feb. 6, 2017.
(60) Provisional application No. 62/436,487, filed on Dec. 20, 2016.

(51) Int. Cl. H04N 9/73; H04N 5/243; H04N 5/235; H04N 5/232; H04N 5/225; H04N 9/68; H04N 9/77; H04N 9/097

(52) U.S. Cl. CPC H04N 9/735; H04N 5/243; H04N 5/2354; H04N 9/097; H04N 5/2256; H04N 9/68; H04N 9/77; H04N 5/23229

(57) ABSTRACT

A light locus of an imaging system is generated in a chromaticity space of two dimensions. The light locus represents a collection of candidate illuminants. The imaging system captures a gray-card image under each of N light sources to obtain N points in the chromaticity space, wherein N is a positive integer no less than three. Each point in the chromaticity space is described by a coordinate pair calculated from red (R), green (G) and blue (B) tristimulus values of the point. A second order polynomial function is calculated by curve-fitting the N points, and the light locus is generated to represent the second order polynomial in the chromaticity space. One of the candidate illuminants from the light locus is then identified as an illuminant for an image captured by the imaging system. A method for color transformation between two imaging systems in a chromaticity space is also described.

### CROSS-REFERENCE TO RELATED APPLICATIONS

This application is a continuation-in-part of U.S. patent application Ser. No. 15/425,113 filed on Feb. 6, 2017, and claims the benefit of U.S. Provisional Application No. 62/436,487 filed on Dec. 20, 2016, the entirety of which is incorporated by reference herein.

### TECHNICAL FIELD

Embodiments of the invention relate to the fields of color photography, digital cameras, color printing, and digital color image processing.

### BACKGROUND

All consumer color display devices are calibrated so that when the values of color channels Red (R)=Green (G)=Blue (B), the color is displayed at a standard “white point” chromaticity, mostly D65 or D50 according to the International Commission on Illumination (abbreviated as CIE) standard. Digital color cameras using complementary metal-oxide semiconductor (CMOS) or charge-coupled device (CCD) sensors have different sensitivities for RGB channels, resulting in raw images with some color cast (e.g., greenish). Furthermore, the color of an object varies as a function of the color of the light source (e.g., tungsten light or daylight), and the mutual reflection from ambient objects. Therefore, it is often necessary to adjust the “white point” of a raw image before one can process and display the image in proper color reproduction. This white point adjustment is called white balance (WB), and it is typically performed by applying proper gains to the color channels so that neutral objects (such as black, gray, and white) in the image are rendered with approximately equal R, G, B values. In digital cameras, the white point can be manually or automatically adjusted. Automatic white balance (AWB) is thus an important operation in color imaging applications.

Some AWB methods include the step of identifying the light source (also referred to an illuminant) in a given image. The illuminant can be selected from a collection of candidate illuminants that are likely to occur in user-produced images. An illuminant can be described or represented by its RGB values, also referred to as the tristimulus values of the illuminant. Generally, the candidate illuminants associated with different camera models are described by different RGB values; that is, the same light source captured by different camera models has different tristimulus values. A conventional method for generating a representation of a collection of candidate illuminants associated with a camera is to take hundreds or thousands gray-card embedded photos with the camera under various light sources. This method is time-consuming, and has to be repeated for every camera model. Therefore, it is highly desirable to develop an efficient technique for generating a representation of a collection of candidate illuminants associated with a camera.

### SUMMARY

In one embodiment, a method is provided for generating and utilizing a light locus of an imaging system in a chromaticity space of two dimensions, wherein the light locus represents a collection of candidate illuminants. The method comprises: capturing, by the imaging system, a gray-card image under each of N light sources to obtain N points in the chromaticity space, wherein N is a positive integer no less than three. Each point in the chromaticity space is described by a coordinate pair calculated from red (R), green (G) and blue (B) tristimulus values of the point. The method further comprises: calculating a second order polynomial function by curve-fitting the N points; generating the light locus to represent the second order polynomial in the chromaticity space; and identifying one of the candidate illuminants from the light locus as an illuminant for an image captured by the imaging system.

In another embodiment, a method is provided for color transformation between two imaging systems in a chromaticity space of two dimensions. The method comprises: calculating a first set of points in the chromaticity space from a first set of tristimulus values obtained by a first imaging system which captures color images of objects under a set of light sources, wherein each tristimulus values include a red (R) value, a green (G) value and a blue (B) value; calculating a second set of points in the chromaticity space from a second set of tristimulus values obtained by a second imaging system which captures color images of the objects under the set of light sources, wherein each point in the first set of points has a corresponding point in the second set of points, and corresponding points are obtained from a same object captured by the two imaging systems under a same light source; estimating a color transformation matrix that transforms the first set of tristimulus values to the second set of tristimulus values for each pair of the corresponding points; and applying the estimated color transformation matrix to convert color signals generated by the first imaging system.

In yet another embodiment, a system is provided for generating and utilizing a light locus in a chromaticity space of two dimensions. The light locus represents a collection of candidate illuminants. The system comprises: an image sensor to capture a gray-card image under each of N light sources to obtain N points in the chromaticity space, wherein N is a positive integer no less than three, and wherein each point in the chromaticity space is described by a coordinate pair calculated from red (R), green (G) and blue (B) tristimulus values of the point. The system further comprises a processor coupled to the image sensor. The processor is operative to: calculate a second order polynomial function by curve-fitting the N points; generate the light locus to represent the second order polynomial in the chromaticity space; and identify one of the candidate illuminants from the light locus as an illuminant for an image captured by the imaging system.

In yet another embodiment, a system is provided for performing color transformation from a reference system in a chromaticity space of two dimensions. The system comprises: an image sensor to capture color images of objects under a set of light sources; and a processor coupled to the image sensor. The processor is operative to: calculate a target set of points in the chromaticity space from a target set of tristimulus values obtained from the captured color images of the objects under the set of light sources, wherein each tristimulus values include a red (R) value, a green (G) value and a blue (B) value; and calculate a reference set of points in the chromaticity space from a reference set of tristimulus values obtained by the reference system which captures color images of the objects under the set of light sources. Each point in the reference set of points has a corresponding point in the target set of points, and corresponding points are obtained from a same object captured by the system and the reference system under a same light source. The processor is further adapted to estimate a color transformation matrix that transforms the reference set of tristimulus values to the target set of tristimulus values for each pair of the corresponding points; and apply the estimated color transformation matrix to convert color signals generated by the reference system.

The embodiments of the invention improve the efficiency of calibrating color signals in an imaging system, as well as the generation of a light locus for an imaging system. The light locus may be used as a collection of candidate illuminants for the AWB methods to be described below. Advantages of the embodiments will be explained in detail in the following descriptions.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1A illustrates an image processing pipeline for color correction according to one embodiment.

FIG. 1B illustrates a device that includes the image processing pipeline of FIG. 1A according to one embodiment.

FIG. 2 illustrates the projection of two color surfaces on a plane that is perpendicular to a light source vector.

FIG. 3 is a diagram illustrating an automatic white balance module that performs a minimum projected area (MPA) method according to one embodiment.

FIGS. 4A, 4B and 4C illustrate examples of projection results using three different candidate illuminants.

FIG. 5 is a diagram illustrating an automatic white balance module that performs a block MPA method according to one embodiment.

FIG. 6 is a flow diagram illustrating a MPA method according to one embodiment.

FIG. 7 is a block diagram illustrating an automatic white balance module that performs a minimum total variation (MTV) method according to one embodiment.

FIG. 8 is a flow diagram illustrating a MTV method according to one embodiment.

FIG. 9 is a flow diagram illustrating a method for automatic white balance according to one embodiment.

FIG. 10 illustrates an example of a light locus of a camera according to one embodiment.

FIG. 11 illustrates one example of the verification of a light locus according to one embodiment.

FIG. 12 is a flow diagram illustrating a method for generating and utilizing a light locus of an imaging system in a chromaticity space according to one embodiment.

FIG. 13 is a flow diagram illustrating a method for color transformation between two imaging systems in a chromaticity space according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

In the first part of the following description, systems and methods based on surface reflection decomposition are provided for performing automatic white balance (AWB). The systems and methods are robust and relatively insensitive to scene contents when compared with those based on conventional AWB algorithms. The systems and methods do not rely on detailed scene statistics or a large image database for training. A minimum projected area (MPA) method and a minimum total variation (MTV) method are described, both based on decomposing the surface reflection into a specular component and a diffuse component, and on the cancellation of the specular component. In the second part of the following description, efficient methods and systems for generating a light locus for a camera are described. In the third part of the following description, efficient methods and systems for generating a color transformation matrix based on chromaticity matching are described.

As used herein, the term “tricolor values,” or equivalently “tristimulus values,” “RGB values” or “RGB channels,” refers to the three color values (red, green, blue) of a color image. The terms “illuminant” and “light source” are used interchangeably. Furthermore, a chroma image refers to a color difference image, which can be computed from taking the difference between one color channel and another color channel, or the difference between linear combinations of color channels. Additionally, although the term “camera” is used throughout the description as an example, it is understood that the methods and systems described herein are applicable to any imaging systems.

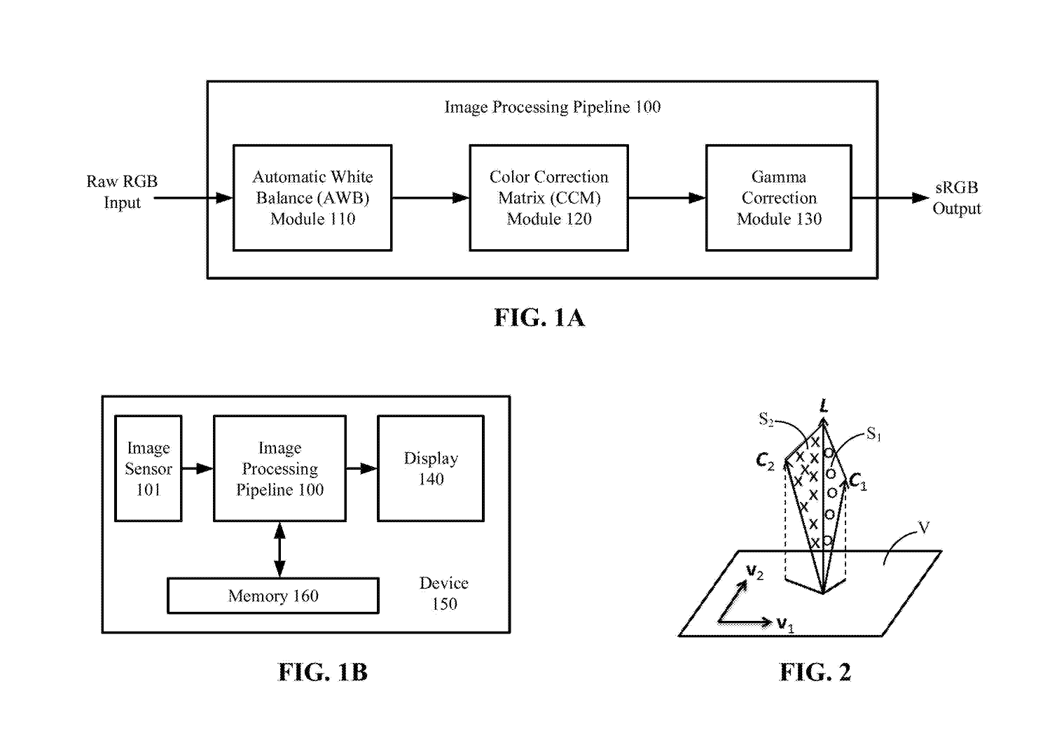

FIG. 1A illustrates an example of an image processing pipeline 100 that performs color correction according to one embodiment. The image processing pipeline 100 includes an AWB module 110, which receives raw RGB values as input, and outputs white-balance corrected RGB values. The raw RGB values may be generated by an image sensor, a camera, a video recorder, etc. The operations of the AWB module 110 will be explained in detail with reference to FIGS. 2-9. The image processing pipeline 100 further includes a color correction matrix (CCM) module 120, which performs 3×3 matrix operations on the RGB values output from the AWB module 110. The CCM module 120 can reduce the difference between the spectral characteristics of the image sensor and the spectral response of a standardized color device” (e.g., an sRGB color display). The image processing pipeline 100 may further include a gamma correction module 130, which applies a nonlinear function on the RGB values output from the CCM module 120 to compensate the nonlinear luminance effect of display devices. The output of the image processing pipeline 100 is a collection of standard RGB (sRGB) values ready to be displayed. In one embodiment, the image processing pipeline 100 includes a plurality of processing elements (e.g., Arithmetic and Logic Units (ALUs)), general-purpose processors, special-purpose circuitry, or any combination of the above, for performing the function of the AWB module 110, the CCM module 120 and the gamma correction module 130.

FIG. 1B illustrates a system in the form of a device 150 that includes the image processing pipeline 100 of FIG. 1A according to one embodiment. In addition to the image processing pipeline 100, the device 150 includes a memory 160 for storing image data or intermediate image data to be processed by the image processing pipeline 100, an image sensor 101 for capturing images, and a display 140 for displaying an image with sRGB values. In one embodiment, the image processing pipeline 100 may be or include one or more processors and/or digital image processing circuitry. It is understood that the device 150 may include additional components, including but not limited to: user interface, network interface, etc. In one embodiment, the device 150 may be an imaging system such as a digital camera; alternatively, the device 150 may be part of a computing and/or communication device, such as a computer, laptop, smartphone, smart watch, etc.

Before describing the embodiments of the AWB module 110, it is helpful to first explain the principles according to which the AWB module 110 operates.

Let ƒ(θ; λ) be the bidirectional spectral reflectance distribution function (BSRDF), where θ represents all angle-dependent factors and λ the wavelength of light. The BSRDF of most colored object surfaces can be described as a combination of two reflection components, an interface reflection (specular) component and a body reflection (diffuse) component. The interface reflection is often non-selective, i.e., it reflects light of all visible wavelength equally well. This model is called the neutral interface reflection (NIR) model. Based on the NIR model, the BSRDF ƒ(θ; λ) can be expressed as:

ƒ(θ;λ)=ρ(λ)h(θ)+ρₛk(θ), (1)

where ρ(λ) is the diffuse reflectance factor, ρₛ is the specular reflectance factor, and h(θ) and k(θ) are the angular dependence of the reflectance factors. A key feature of the NIR model is that the spectral factor and the geometrical factor in each reflection component are completely separable.

Assume that L(λ) is the spectral power distribution of the illuminant, and Sᵣ(λ), S_{g}(λ), and S_{b}(λ) are the three sensor fundamentals (i.e., spectral responsivity functions). The RGB color space can be derived as:

$$R = \int L ( λ ) f ( θ ; λ ) {S}_{r} ( λ ) d λ = h ( θ ) \int L ( λ ) ρ ( λ ) {S}_{r} ( λ ) d λ + {ρ}_{s} k ( θ ) \int L ( λ ) {S}_{r} ( λ ) d λ , G = h ( θ ) \int L ( λ ) ρ ( λ ) {S}_{g} ( λ ) d λ + {ρ}_{s} k ( θ ) \int L ( λ ) {S}_{g} ( λ ) d λ , B = h ( θ ) \int L ( λ ) ρ ( λ ) {S}_{b} ( λ ) d λ + {ρ}_{s} k ( θ ) \int L ( λ ) {S}_{b} ( λ ) d λ . \qquad ( 2 )$$

### Let

$${L}_{r} = \int L ( λ ) {S}_{r} ( λ ) d λ , {L}_{g} = \int L ( λ ) {S}_{g} ( λ ) d {λL}_{b} = \int L ( λ ) {S}_{b} ( λ ) d λ , \\ {ρ}_{r} = \frac{\int L ( λ ) ρ ( λ ) {S}_{r} ( λ ) d λ}{\int L ( λ ) {S}_{r} ( λ ) d λ} , {ρ}_{g} = \frac{\int L ( λ ) ρ ( λ ) {S}_{g} ( λ ) d λ}{\int L ( λ ) {S}_{g} ( λ ) d λ} , \\ {ρ}_{b} = \frac{\int L ( λ ) ρ ( λ ) {S}_{b} ( λ ) d λ}{\int L ( λ ) {S}_{r} ( λ ) d λ} . \qquad$$

### Then,

$$R = {L}_{r} [ {ρ}_{r} h ( θ ) + {ρ}_{s} k ( θ ) ] , \\ G = {L}_{g} [ {ρ}_{g} h ( θ ) + {ρ}_{s} k ( θ ) ] , \\ B = {L}_{b} [ {ρ}_{b} h ( θ ) + {ρ}_{s} k ( θ ) ] , \qquad ( 3 )$$

where Lᵣ, L_{g}, and L_{b} are the tristimulus values of the light source. The RGB color space can be re-written in matrix form as:

$$[ \begin{matrix}R \\ G \\ B\end{matrix} ] = h ( θ ) [ \begin{matrix}{L}_{r} & 0 & 0 \\ 0 & {L}_{g} & 0 \\ 0 & 0 & {L}_{b}\end{matrix} ] [ \begin{matrix}{ρ}_{r} \\ {ρ}_{g} \\ {ρ}_{b}\end{matrix} ] + {ρ}_{s} k ( θ ) [ \begin{matrix}{L}_{r} \\ {L}_{g} \\ {L}_{b}\end{matrix} ] . \qquad ( 4 )$$

Let ν₁ and ν₂ be two independent vectors in the RGB space. If the RGB values are projected on plane V spanned by ν₁ and ν₂, the projected coordinates will be:

$${[ \begin{matrix}{v}_{1} & {v}_{2}\end{matrix} ]}^{T} \begin{matrix}[ \begin{matrix}R \\ G \\ B\end{matrix} ] = {h ( θ ) [ \begin{matrix}{v}_{1} & {v}_{2}\end{matrix} ]}^{T} [ \begin{matrix}{L}_{r} & 0 & 0 \\ 0 & {L}_{g} & 0 \\ 0 & 0 & {L}_{b}\end{matrix} ] [ \begin{matrix}{ρ}_{r} \\ {ρ}_{g} \\ {ρ}_{b}\end{matrix} ] + {ρ}_{s} {k ( θ ) [ \begin{matrix}{v}_{1} & {v}_{2}\end{matrix} ]}^{T} [ \begin{matrix}{L}_{r} \\ {L}_{g} \\ {L}_{b}\end{matrix} ] . & ( 5 )\end{matrix}$$

Let L=[Lᵣ L_{g} L_{b}]^{T} be the light source vector. The second term in equation (5) disappears when [ν₁ ν₂]^{T} L=0. It means that when plane V is perpendicular to the light source vector L, the specular component is canceled.

FIG. 2 illustrates an example of projecting the colors of two surfaces on the plane V. According to the NIR model, every color vector of light reflected from a given surface (e.g., S₁) is a linear combination of the specular component (represented by the light source vector L) and the diffuse component (represented by C₁). All the colors of S₁ are on the same plane as L and C₁. Similarly, all the colors of another surface (e.g., S₂) are on the same plane as L and C₂. Therefore, all the colors under the same light source are on the planes that share a common vector L. If all the colors are projected along the light source vector L, their projections will form several lines and those lines intersect at one point which is the projected point of the light source vector. If the projection direction is not along the light source vector L (i.e., if V is not perpendicular to L), then the specular component is not canceled. In this case, the projected colors will no longer form lines on plane V, but instead will spread out over two-dimensional area of plane V. This two-dimensional area, referred to as the projected area on Plane V, can be calculated when ν₁ and ν₂ are orthonormal. Plane V varies when ν₁ and ν₂ change. By changing ν₁ and ν₂, the projected area will become the smallest when plane V is perpendicular to the light source vector L. It does not matter which specific ν₁ and ν₂ are used as the basis vectors, as all of them produce substantially the same results.

In the AWB calculations, the light source vector L for the ground truth light source is unknown. The MPA method varies plane V by choosing different candidate illuminants. From the chosen light source vector L=(Lᵣ, L_{g}, L_{b}) of the candidate illuminant, the orthonormal basis vectors ν₁ and ν₂ can be computed, and a given image's projected area on the plane spanned by ν₁ and ν₂ can also be computed. The projected area is the smallest when the chosen light source vector L is the closest to the ground truth light source of the image.

In one embodiment, the orthonormal basis vectors may be parameterized as follows:

$$\begin{matrix}{v}_{1} ( α , β ) = {\frac{1}{\sqrt{{α}^{2} + 1}} [ \begin{matrix}α & - 1 & 0\end{matrix} ]}^{T} , & ( 6 ) \\ {v}_{2} ( α , β ) = {\frac{1}{\sqrt{{α}^{2} + {α}^{4} + {{β}^{2} ( {α}^{2} + 1 )}^{2}}} [ \begin{matrix}- α & - {α}^{2} & β ( {α}^{2} + 1 )\end{matrix} ]}^{T} . & ( 7 )\end{matrix}$$

When α=L_{g}/Lᵣ and β=L_{g}/L_{b}, plane V(α, β) is perpendicular to L.

In one embodiment, the search range for the light sources is narrowed to a subspace where light sources are more likely to occur, since searching through all possible planes V(α, β) is very time consuming. Narrowing the search range also has the benefit of reducing the possibility of finding the wrong light source. In one embodiment, the search range can be a set of illuminants commonly occurred in consumer images of the intended application domain. The term “consumer images” refers to color images that are typically seen on image display devices used by content consumers. Alternatively or additionally, a suitable blending of the daylight locus and the blackbody radiator locus may be used. This blending can provide a light locus covering most illuminants in the consumer images. To search for the light source of an image, the MPA method calculates the image's projected area for each candidate illuminant in a set of candidate illuminants along the light locus. The candidate illuminant that produces the minimum projected area is the best estimate of the scene illuminant (i.e., the ground truth light source), and the image is white balanced according to that scene illuminant. In one embodiment, the MPA method minimizes the following expression:

$${arg min}_{α , β} w ( α , β ) Area ( α , β ) , \qquad ( 8 )$$

where w(α, β) is a bias function, and Area(α, β) is the projected area on plane V(α, β), which is spanned by ν₁(α, β) and ν₂ (α, β). The bias function may be used to modify a projected area and thus improve the performance of the MPA method. The bias function relies on the gross scene illuminant distribution, but not the scene content. Therefore, the same bias function can work for any camera model after the camera is calibrated. Details of the bias function w(α, β) will be provided later. In alternative embodiments, the bias function may be omitted (i.e., set to one).

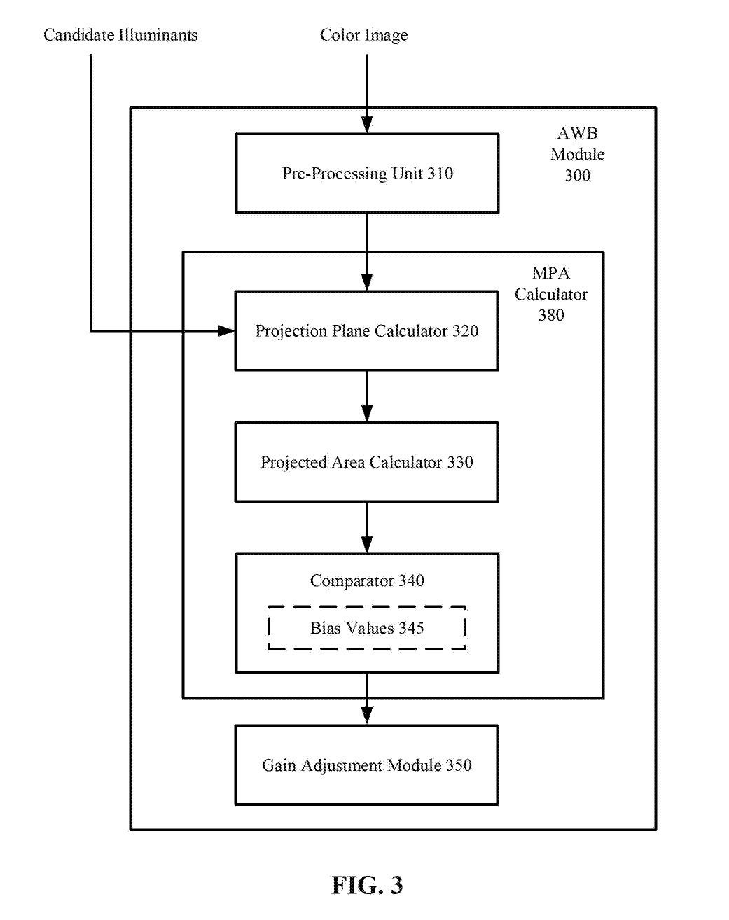

FIG. 3 illustrates an AWB module 300 for performing the MPA method according to one embodiment. The AWB module 300 is an example of the AWB module 110 of FIG. 1A. The AWB module 300 includes a pre-processing unit 310, which processes raw RGB data of an input image to remove over-exposed, under-exposed and saturated pixels. The removal of these pixels can speed up AWB computation and reduce noise. In one embodiment, a pixel is deemed over-exposed and removed if one or more of its R value, G value and B value is within a predetermined vicinity from the maximum of that pixel's color data range; in other words, when one or more of the pixel's color channels is greater than a threshold. After these pixels are removed, the pre-processing unit 310 may group-average the input image by dividing the image into multiple groups of neighboring pixels, and calculating a weighted average of the tricolor values of the neighboring pixels in each group. The weight for each group may be one or another number. In one embodiment, after the calculating the group average, the pre-processing unit 310 may remove under-exposed pixels from the image. A pixel is over-exposed if the sum of its R value, G value and B value is above a first threshold; a pixel is under-exposed if the sum of its R value, G value and B value is below a second threshold. The pre-processing unit 310 may also remove saturated pixels from the image. A pixel is saturated if one of its R value, G value and B value is below a predetermined threshold.

In one embodiment, after the pixel removal and group averaging operations, the pre-processing unit 310 may sub-sample the image to produce a pre-processed image. The pre-processed image is fed into an MPA calculator 380 in the AWB module 300 for MPA calculations.

In one embodiment, the MPA calculator 380 includes a projection plane calculator 320 and a projected area calculator 330. The projection plane calculator 320 calculates two orthonormal vectors ν₁ and ν₂ that span a plane perpendicular to a light source vector (Lᵣ, L_{g}, L_{b}) of a candidate illuminant. In one embodiment, the projection plane calculator 320 calculates ν₁ and ν₂ according to equations (6) and (7), where a and are given or calculated from a candidate illuminant.

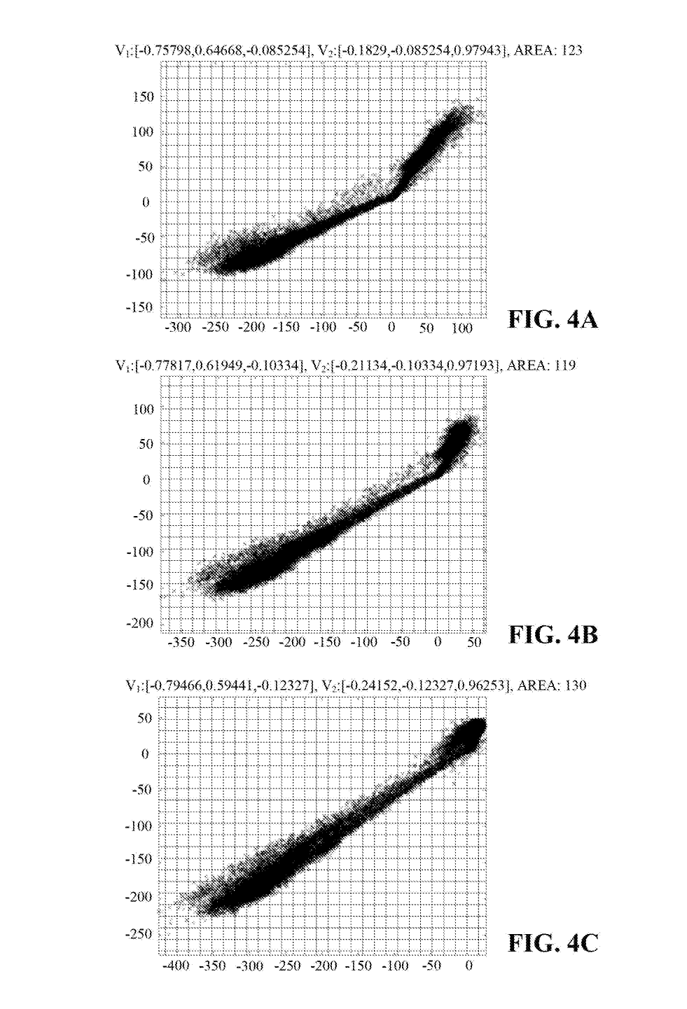

After the projection plane is determined, the projected area calculator 330 projects the RGB values of each pixel in the pre-processed image to that projection plane. The result of the projection is a collection of points that fall onto the projection plane. If each color is represented as an ideal point, then the result of the projection will produce a set of scattered dots on the projected plane, as shown in the examples of FIGS. 4A, 4B and 4C, each of which illustrates a projection result using a different candidate illuminant. The local dot density becomes higher when the projection is along the ground truth light source vector. However, computing dot density requires a large amount of computations. In one embodiment, the projection plane is divided into a set of spatial bins (e.g., squares). A square is counted when one or more pixels are projected into that square. The total number of counted squares may be used as an estimate of the projected area.

Referring to FIGS. 4A, 4B and 4C, in each example, the ‘x’ marks represent the projection points of all pixels of the image. When the candidate illuminant is closer to the ground truth, the total projected area marked by ‘x’s becomes smaller. Each example uses a different candidate illuminant described by the orthonormal bases ν₁ and ν₂. The candidate illuminant that produces the minimum projected area of 119 in FIG. 4B has the smallest area, and is therefore the closest to the ground truth among the three candidate illuminants.

Referring again to FIG. 3, after the projected area calculator 330 calculates the projected areas for a set of different candidate illuminants, a comparator 340 compares the projected areas and identifies a candidate illuminant that produces the minimum projected area. In one embodiment, as an option to improve the AWB results, the comparator 340 may multiply each projected area with the aforementioned bias function, shown herein as a bias value 345 (i.e., a weight), before the comparison. The bias values 345 may be determined based on prior knowledge about how frequently an illuminant along the light locus may occur in consumer images. That is, the bias values 345 represent the prior knowledge of scene illuminant distribution, and are not related to scene contents. In one embodiment, each candidate illuminant is associated with a bias value, which may be denoted as a function w(α, β), where α and β are color ratios of the candidate illuminant. The bias values are stable from one camera model to another camera model.

After the comparator 340 identifies a candidate illuminant that produces the minimum projected area, a gain adjustment unit 350 adjusts the color gain of the input image according to the color ratios α and β of the candidate illuminant.

For an image with multiple different colored objects, the projected area is often minimized when the projection is along the light source vector. However, for images of a single dominant color, the minimum projected area can occur when either the specular component or the diffuse component of the dominant color is canceled. In order to better handle such images of few colors, the search is constrained to the minimum projected area caused by the cancellation of the specular component, not by the diffuse component of the dominant color. One way is to search for the candidates which are close to where the potential light sources are located in the chromaticity space. Therefore, the minimum projected area is searched along the light locus which goes through the population of the known light sources.

In one embodiment, a chromaticity coordinate system (p, q) may be used to parameterize the distribution of light locus in the chromaticity domain with reduced distortion. The coordinate system (p, q) is defined as:

$$p = \frac{1}{\sqrt{2}} r - \frac{1}{\sqrt{2}} b , \\ q = - \frac{1}{\sqrt{6}} r + \frac{2}{\sqrt{6}} g - \frac{1}{\sqrt{6}} b , \qquad ( 9 )$$

where r=R/(R+G+B), g=G/(R+G+B), and b=B/(R+G+B). Since r+g+b=1, any given (r, g, b) values as well as the (p, q) values derived therefrom can be represented by a point in a two-dimensional (2D) space called the chromaticity space. Any point in the chromaticity space can be described by a coordinate pair in a 2D coordinate system. The (r, g, b) values as well as the corresponding (p, q) values are called chromaticity values. It is noted that RGB values are 3D values; normalizing the RGB values to intensity-invariant (r, g, b) values reduces one degree of freedom. The remaining two degrees of freedom can be a curved surface or a plane.

For a candidate illuminant (Lᵣ, L_{g}, L_{b}), its (p, q) coordinates can be determined by replacing R, G, B values in equations (9) with the Lᵣ, L_{g}, L_{b} values.

A light locus may be obtained by fitting the color data taken by a reference camera under different illuminants. For example, a curve fitting from three types of light sources: shade, daylight, and tungsten can provide a very good light locus. In one embodiment, a given light locus may be represented by a second-order polynomial function in the (p, q) domain having the form of:

q=a₀p²+a₁p+α₂. (10)

Given (p, q), the following equations calculate (r, g, b):

$$r = \frac{1}{\sqrt{2}} p - \frac{1}{\sqrt{6}} q + \frac{1}{3} , \\ g = \frac{\sqrt{6}}{3} q + \frac{1}{3} , \\ b = - \frac{1}{\sqrt{2}} p - \frac{1}{\sqrt{6}} q + \frac{1}{3} . \qquad ( 11 )$$

The color ratios α and β can be obtained by:

$$α = \frac{g}{r} , β = \frac{g}{b} . \qquad ( 12 )$$

Accordingly, given a (p, q) along the light locus, the color ratios α and β can be computed. Using equations (6) and (7), the orthonormal vectors ν₁(α, β) and ν₂ (α, β) can be computed, and the projected area of an image on plane V spanned by ν₁(α, β) and ν₂ (α, β) can also be computed.

When a scene is illuminated by a single dominant light source, the MPA method can estimate the light source accurately. However, some scenes have more than one light source. In one embodiment, a block MPA method is used to handle such multiple-illuminant scenarios. With the block MPA method, an image is divided into several blocks and the MPA method is applied to each block.

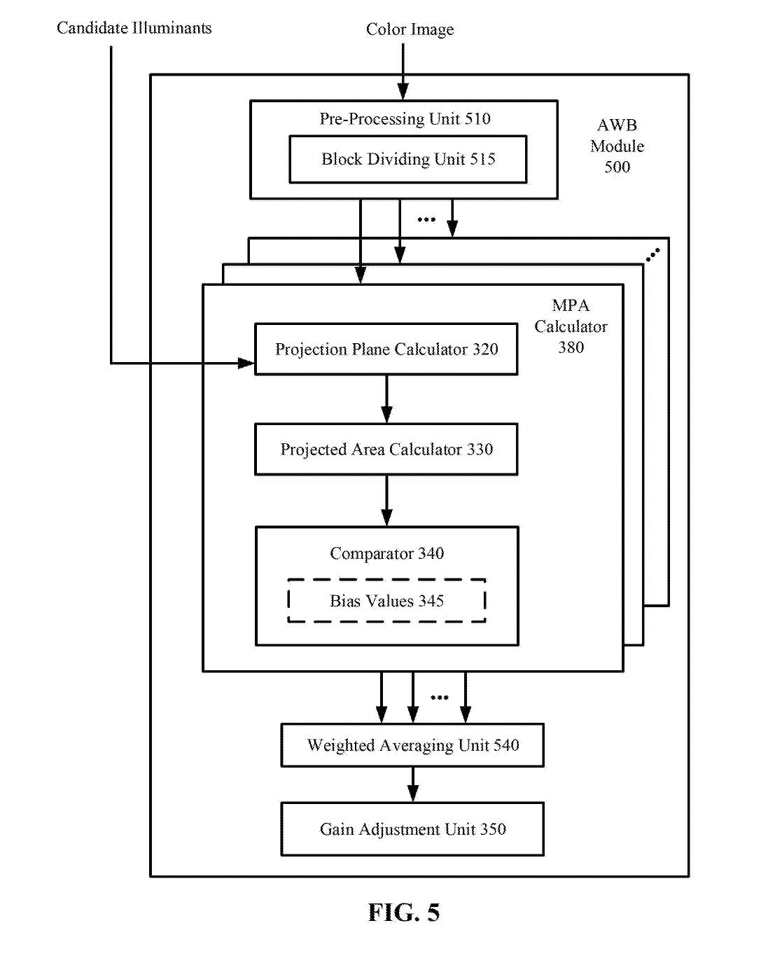

FIG. 5 illustrates an AWB module 500 for performing the block MPA method according to one embodiment. The AWB module 500 is an example of the AWB module 110 of FIG. 1A. The AWB module 500 includes a pre-processing unit 510, which further includes a block dividing unit 515 to divide an input image into multiple blocks. The pre-processing unit 510 performs the same pixel removal operations as the pre-processing unit 310 of FIG. 3 on each block to remove over-exposed, under-exposed and saturated pixels. The pre-processing unit 510 also determines whether each block has a sufficient number of pixels (e.g., 10 pixels) for the MPA method after the pixel removal operations. If less than a threshold number of blocks (e.g., half of the number of blocks) have sufficient number of pixels for the MPA method, the pre-processing unit 510 re-divides the image into fewer number of blocks, such that the number of new blocks in the image is greater than the threshold number.

In one embodiment, the AWB module 500 includes one or more MPA calculators 310 to execute the MPA method on each block. The per-block results are gathered by an weighted averaging unit 540, which averages the chromaticity coordinate p first, then finds the other chromaticity coordinate q based on the fitted curve (e.g., the second-order polynomial function in (10)) for a given light locus. In one embodiment, the weighted averaging unit 540 applies a weight to each block; for example, the weight of a block having the main object may be higher than other blocks. In alternative embodiment, the weighted averaging unit 540 may apply the same weight to all blocks. The output of the weighted averaging unit 540 is a resulting candidate illuminant or a representation thereof. The gain adjustment unit 350 then adjusts the color gain of the input image using the color ratios α and β of the resulting candidate illuminant.

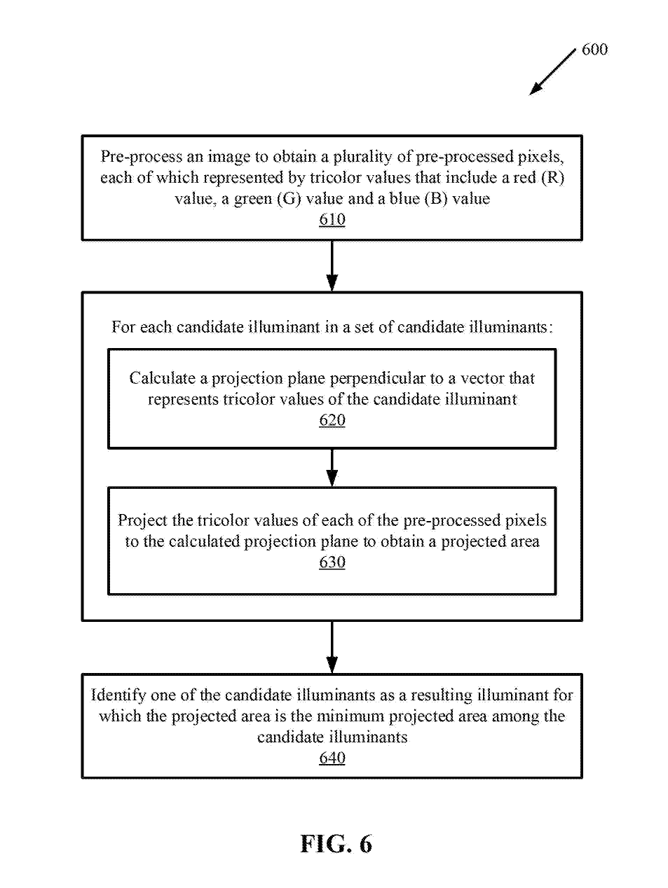

FIG. 6 is a flow diagram illustrating a MPA method 600 performed on a color image according to one embodiment. The MPA method 600 may be performed by a device, such as the device 150 of FIG. 1B; more specifically, the MPA method 600 may be performed by the AWB module 110 of FIG. 1A, the AWB module 300 of FIG. 3 and/or the AWB module 500 of FIG. 5.

The MPA method 600 begins with a device pre-processing an image to obtain pre-processed pixels, each of which represented by tricolor values that include a red (R) value, a green (G) value and a blue (B) value (step 610). For each candidate illuminant in a set of candidate illuminants, the device performs the following operations: calculating a projection plane perpendicular to a vector that represents tricolor values of the candidate illuminant (step 620), and projecting the tricolor values of each of the pre-processed pixels to the calculated projection plane to obtain a projected area (step 630). One of the candidate illuminants is identified as a resulting illuminant for which the projected area is the minimum projected area among the candidate illuminants (step 640). The device may use the color ratios of the resulting illuminant to adjust the color gains of the image.

According to another embodiment, AWB may be performed using the MTV method, which is also based on the same principle as the MPA method by seeking to cancel the specular component. According to the NIR model, a pair of chroma images, (αC₁−C₂) and (βC₃−C₂), can be created from a given image by scaling one color channel and taking the difference with another color channel. (C₁, C₂, C₃) is the linear transformation of tricolor values (R,G,B).

$$[ \begin{matrix}{C}_{1} \\ {C}_{2} \\ {C}_{3}\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}R \\ G \\ B\end{matrix} ] \qquad ( 13 )$$

Both (αC₁−C₂) and (βC₃−C₂) are functions of spatial locations in the image. The two chroma images can be expressed as:

$$( α {C}_{1} - {C}_{2} ) = [ ( α {a}_{11} - {a}_{21} ) {L}_{r} {ρ}_{r} + ( α {a}_{12} - {a}_{22} ) {L}_{g} {ρ}_{g} + ( α {a}_{13} - {a}_{23} ) {L}_{b} {ρ}_{b} ] h ( θ ) + [ ( α {a}_{11} - {a}_{21} ) {L}_{r} + ( α {a}_{12} - {a}_{22} ) {L}_{g} + ( α {a}_{13} - {a}_{23} ) {L}_{b} ] {ρ}_{s} k ( θ ) , \\ ( β {C}_{3} - {C}_{2} ) = [ ( β {a}_{31} - {a}_{21} ) {L}_{r} {ρ}_{r} + ( β {a}_{32} - {a}_{22} ) {L}_{g} {ρ}_{g} + ( β {a}_{33} - {a}_{23} ) {L}_{b} {ρ}_{b} ] h ( θ ) + [ ( β {a}_{31} - {a}_{21} ) {L}_{r} + ( β {a}_{32} - {a}_{22} ) {L}_{g} + ( β {a}_{33} - {a}_{23} ) {L}_{b} ] {ρ}_{s} k ( θ ) . \qquad ( 14 )$$

When α=(a₂₁Lᵣ+a₂₂L_{g}+a₂₃L_{b})/(a₁₁Lᵣ+a₁₂L_{g}+a₁₃L_{b}) and β=(a₂₁Lᵣ+a₂₂ L_{g}+a₂₃L_{b})/(a₃₁Lᵣ+a₃₂L_{g}+a₃₃L_{b}):

(αC₁−C₂)=[(αa₁₁−a₂₁)Lᵣρᵣ+(αa₁₂−a₂₂)L_{g}ρ_{g}+(αa₁₃−a₂₃)L_{b}ρ_{b}]h(θ),

(βC₃−C₂)=[(βa₃₁−a₂₁)Lᵣρᵣ+(βa₃₂−a₂₂)L_{g}ρ_{g}+(βa₃₃−a₂₃)L_{b}ρ_{d}]h(θ). (15)

The specular component is canceled for both αC₁−C₂ and βC₃−C₂. When the cancellation happens, the total variation of αC₁−C₂ and βC₃−C₂ is greatly reduced because the modulation due to the specular components is gone. There is left only a signal modulation entirely due to the difference in the diffuse components.

By searching along a given light locus, the MTV method finds a candidate illuminant, represented by color ratios α and β, that minimizes the following expression of total variation. The color ratios α and β may be computed from a given point (p, q) on a given light locus using equations (11) and (12). The total variation in this embodiment can be expressed as a sum of absolute gradient magnitudes of the two chroma images in (14):

$$arg {min}_{α , β} {\sum }_{n} \vert ∇ ( α {C}_{1} ( n ) - {C}_{2} ( n ) ) \vert + \vert ∇ ( β {C}_{3} ( n ) - {C}_{2} ( n ) ) \vert . \qquad ( 16 )$$

It is noted that the gradient of a two-dimensional image is a vector that has an x-component and a y-component. For computational efficiency, a simplified one-dimensional approximation of total variation can be used:

$$arg {min}_{α , β} {\sum }_{n} \vert α [ {C}_{1} ( n ) - {C}_{1} ( n + 1 ) ] - [ {C}_{2} ( n ) - {C}_{2} ( n + 1 ) ] \vert + \vert β [ {C}_{3} ( n ) - {C}_{3} ( n + 1 ) ] - [ {C}_{2} ( n ) - {C}_{2} ( n + 1 ) ] \vert \qquad ( 17 )$$

In one embodiment, if any neighboring pixel has been removed due to over-exposure, under-exposure, or color saturation, the gradient of that pixel is excluded from the total variation calculation.

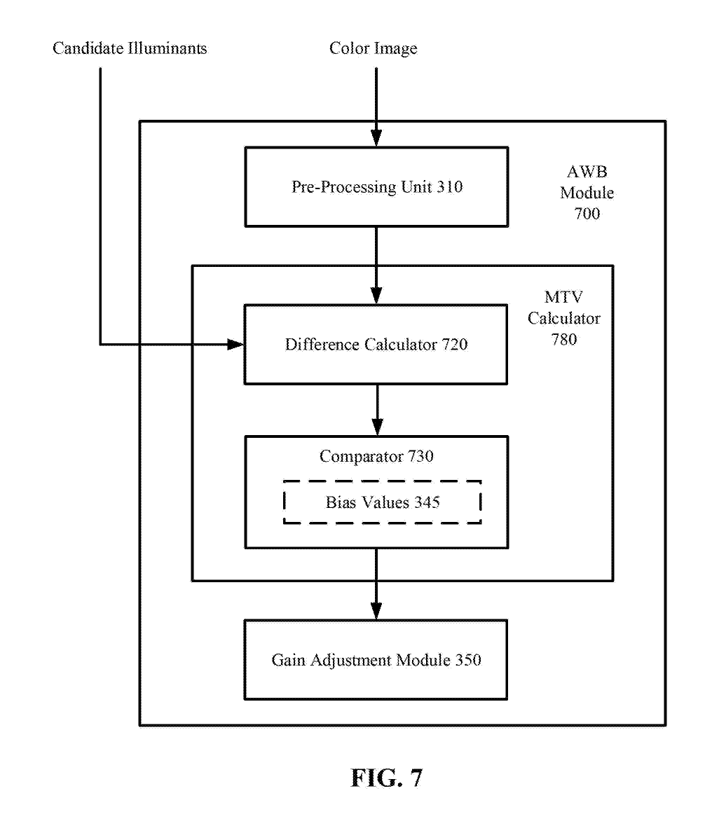

FIG. 7 illustrates an AWB module 700 for performing the MTV method according to one embodiment. The AWB module 700 is another example of the AWB module 110 of FIG. 1A. The AWB module 700 includes the pre-processing unit 310, which processes raw RGB data of an input image to remove over-exposed, under-exposed and saturated pixels. The AWB module 700 further includes an MTV calculator 780, which searches for a minimum total variation solution in a set of candidate illuminants. More specifically, the MTV calculator 780 further includes a difference calculator 720 and a comparator 730. The difference calculator 720 calculates the total variation for each candidate illuminant, and the comparator 730 compares the results from the difference calculator 720 to identify a minimum total variation. In one embodiment, the comparator 730 may multiply each total variation with a bias value 345 (i.e., a weight) before the comparison. The bias values 345 may be determined based on prior knowledge about how frequently an illuminant along the light locus may occur in consumer images. That is, the bias values 345 represent the prior knowledge of scene illuminant distribution, and are not related to scene contents. In one embodiment, each candidate illuminant is associated with a bias value, which may be denoted as a function w(α, β), where a and β are color ratios of the candidate illuminant. The bias values are stable from one camera model to another camera model.

After the comparator 730 identifies the candidate illuminant that produces the minimum total variation, the gain adjustment unit 350 adjusts the color gain of the input image using the color ratios α and β of the candidate illuminant. Experiment results show that the MTV method performs well for a single dominant illuminant as well as multiple illuminants.

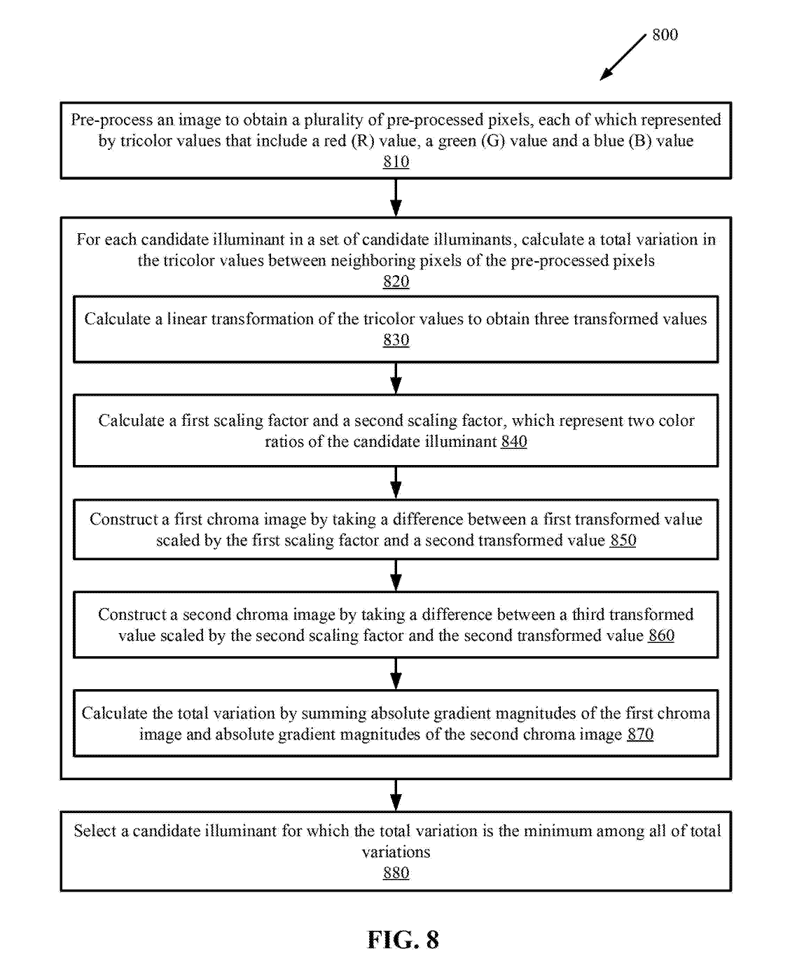

FIG. 8 is a flow diagram illustrating a MTV method 800 performed on a color image according to an alternative embodiment. In this alternative embodiment, a linear transformation is applied to the tricolor values in the calculation of the total variation. The MTV method 800 may be performed by a device, such as the device 150 of FIG. 1B; more specifically, the MTV method 800 may be performed by the AWB module 110 of FIG. 1A and/or the AWB module 700 of FIG. 7.

The MTV method 800 begins with a device pre-processing an image to obtain a plurality of pre-processed pixels, each of which represented by tricolor values that include a red (R) value, a green (G) value and a blue (B) value (step 810). For each candidate illuminant in a set of candidate illuminants, the device calculates a total variation in the tricolor values between neighboring pixels of the pre-processed pixels (step 820). The calculation of the total variation includes the operations of: calculating a linear transformation of the tricolor values to obtain three transformed values (step 830); calculating a first scaling factor and a second scaling factor, which represent two color ratios of the candidate illuminant (step 840); constructing a first chroma image by taking a difference between a first transformed value scaled by the first scaling factor and a second transformed value (step 850); constructing a second chroma image by taking a difference between a third transformed value scaled by the second scaling factor and the second transformed value (step 860); and calculating an indicator value by summing absolute gradient magnitudes of the first chroma image and absolute gradient magnitudes of the second chroma image (step 870). After the total variations of all candidate illuminants are computed, the device selects a candidate illuminant for which the total variation is the minimum among all of total variations (step 880).

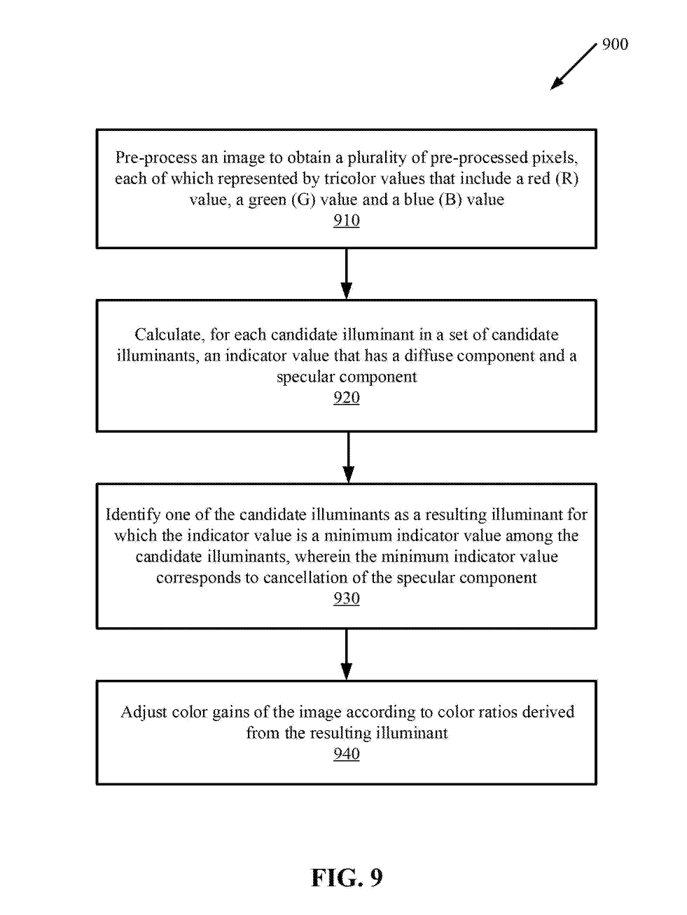

FIG. 9 is a flow diagram illustrating a method 900 for performing automatic white balance on an image according to one embodiment. The method 900 may be performed by a device, such as the device 150 of FIG. 1B; more specifically, the method 900 may be performed by the AWB module 110 of FIG. 1A, the AWB module 300 of FIG. 3, the AWB module 500 of FIG. 5, and/or the AWB module 700 of FIG. 7.

The method 900 begins with a device pre-processing the image to obtain a plurality of pre-processed pixels, each of which represented by tricolor values that include a red (R) value, a green (G) value and a blue (B) value (step 910). For each candidate illuminant in a set of candidate illuminants, the device calculates an indicator value that has a diffuse component and a specular component (step 920). The device then identifies one of the candidate illuminants as a resulting illuminant for which the indicator value is a minimum indicator value among the candidate illuminants, wherein the minimum indicator value corresponds to cancellation of the specular component (step 930). According to color ratios derived from the resulting illuminant, the device adjusts color gains of the image (step 940). In one embodiment, the indicator value is a projected area as described in connection with the MPA method 600 in FIG. 6; in alternative embodiments, the indicator value is a total variation as described in connection with the MTV method 800 in FIG. 8.

In the following description, efficient methods and systems for generating a light locus for a camera are described. As mentioned in the MPA method and the MTV method, a light locus represents a collection of candidate illuminants. A light locus of an imaging system (e.g., a camera) may be described by a mathematical formula, such as the aforementioned second-order polynomial function q=a₀p²+a₁p+a₂ of equation (10) with variables p, q in the chromaticity space. Due to the differences in spectral responsivity of different camera models, typically the coefficients (a₀, a₁, a₂) for different camera models are different; for example, Canon® G9 and Nikon® D5 may use different coefficients in equation (10). One technique for generating the light locus for a camera is using the camera to take a number of gray-card images with each image subject to a different light source. The RGB values of the gray-card image are converted to corresponding (p, q) values using equation (9), and the (p, q) values from all of the captured images are used to solve for the coefficients (a₀, a₁, a₂) in the second-order polynomial function of equation (10). It should be noted that the gray card used herein is not limited to any specific shade of gray. Any gray card with a non-selective, neutral spectral reflectance function may be used. Furthermore, it should be noted that the chromaticity space may be described by a coordinate system different from the (p, q) coordinate system.

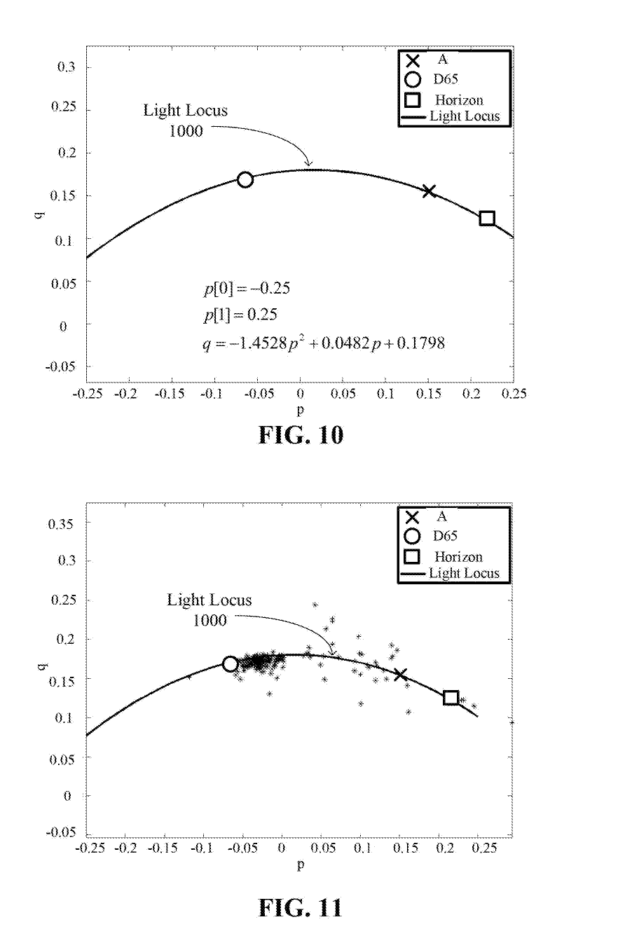

FIG. 10 illustrates an example of a light locus 1000 of a target camera according to one embodiment. In this example, the horizontal axis represents a range of p values and the vertical axis represents a range of q values. Each point on the light locus 1000 represents an illuminant, such as a candidate illuminant in the aforementioned MPA method and the MTV method. The (p, q) values of each point on the light locus 1000 can be converted to corresponding (r, g, b) values using equation (11).

In one embodiment, the light locus 1000 may be generated by curve-fitting at least three points in the (p, q) domain. Each point may be generated by the target camera capturing an image of a gray card under a different light source. That is, at least three different light sources are needed for generating the at least three points in the (p, q) domain for the light locus 1000. Suppose that n different light sources are used to capture n different images of a gray card (where n≥3, and each image is captured under a different light source), the gray card in each image can be described by a set of RGB values. Then equation (9) may be used to convert the n sets of RGB values to corresponding n pairs of (p, q) values. The coefficients (a₀, a₁, a₂) in the second-order polynomial function of equation (10) can be computed by the following:

$$Let A = [ \begin{matrix}{p}_{1}^{2} & {p}_{1} & 1 \\ {p}_{2}^{2} & {p}_{2} & 1 \\ ⋮ & ⋮ & ⋮ \\ {p}_{n}^{2} & {p}_{n} & 1\end{matrix} ] , b = [ \begin{matrix}{q}_{1} \\ {q}_{2} \\ ⋮ \\ {q}_{n}\end{matrix} ] , solve [ \begin{matrix}{a}_{0} \\ {a}_{1} \\ {a}_{2}\end{matrix} ] = {( {A}^{T} A )}^{- 1} {A}^{T} b . \qquad ( 18 )$$

When n=3, three standard light sources may be used for generating three pairs of (p, q) values. In one embodiment, the three standard light sources may be: D65 and Illuminant A according to the CIE standard, and a light source whose spectral distribution approximates a blackbody radiator with a temperature range substantially between 2000 and 2500 degrees Kelvin (K); e.g., 2300 degrees K, such as the light source commonly known as Horizon. Thus, in one embodiment, a user may take only three gray-card images under the three different light sources to generate a light locus for the target camera.

After the second-order polynomial function is constructed by solving equation (18), a user (such as a camera developer or manufacturer) may limit the range of the light locus in the chromaticity space, such that the light sources that typically do not occur in user-produced images are removed from further consideration. The light locus range in the chromaticity space may be limited by an upper bound and a lower bound with respect to the color temperature. In the example of FIG. 10, the upper color temperature bound is the lowest p value of the light locus 1000, and the lower color temperature bound is the highest p value of the light locus.

In the example of FIG. 10, the upper color temperature bound (i.e., p[0]) and the lower color temperature bound (i.e., p[l]) according to experimental results may be set to:

p[0]=p_{D65}−c₀, and

p[1]=p_{H}+c₁, (19)

where c₀ and c₁ are two constant values, p_{D65} is the p value calculated from the D65 light source, and p_{H} is the p value calculated from the light source whose spectral distribution approximates a blackbody radiator with a temperature range substantially between 2000 and 2500 degrees K, such as the Horizon light source. As an example, c₀=0.19 and c₁=0.03. Since p_{D65} and p_{H} may differ from one camera to another, the range of p values for the light locus may also differ from one camera to another.

After obtaining an initial light locus for a camera by curve-fitting, a user may verify the quality of the initial light locus by taking one or more additional images of the gray card under one or more additional light sources that are different from the light sources used for generating the initial light locus. For example, additional daylight sources (e.g., D50) and tungsten light sources may be used for verification. Fluorescent light sources generally do not work as well as the daylight and tungsten light sources. An additional (p, q) pair may be calculated from each of these additional images.

FIG. 11 illustrates one example of the additional (p, q) pairs generated in the chromaticity space for verification of the initial light locus (e.g., the light locus 1000) according to one embodiment. Each additional (p, q) pair generated for verification is marked in FIG. 11. The distance (D) between the initial light locus and each (p, q) pair is calculated. If D>TH (a predetermined threshold) for each of K (p, q) pairs, where K can be any positive integer determined by a user-defined verification policy, the initial light locus is rejected as being inaccurate and an update process begins. Alternatively or additionally, if D>TH for a percentage of these additional (p, q) pairs where the percentage exceeds a value determined by a user-defined verification policy, the initial light locus is rejected as being inaccurate and an update process begins. In one embodiment, the update process incorporates the original (p, q) values that generate the initial light locus and the additional (p, q) values from the additional light sources, and applies all of these (p, q) values to equation (18) to solve for an updated set of (a₀, a₁, a₂). An updated light locus may be plotted in the (p, q) domain using the updated (a₀, a₁, a₂). In one embodiment, the user may verify the updated light locus against yet another set of different light sources until the user-defined verification policy is satisfied. If the initial light locus is not rejected, then the initial light locus is verified and accepted.

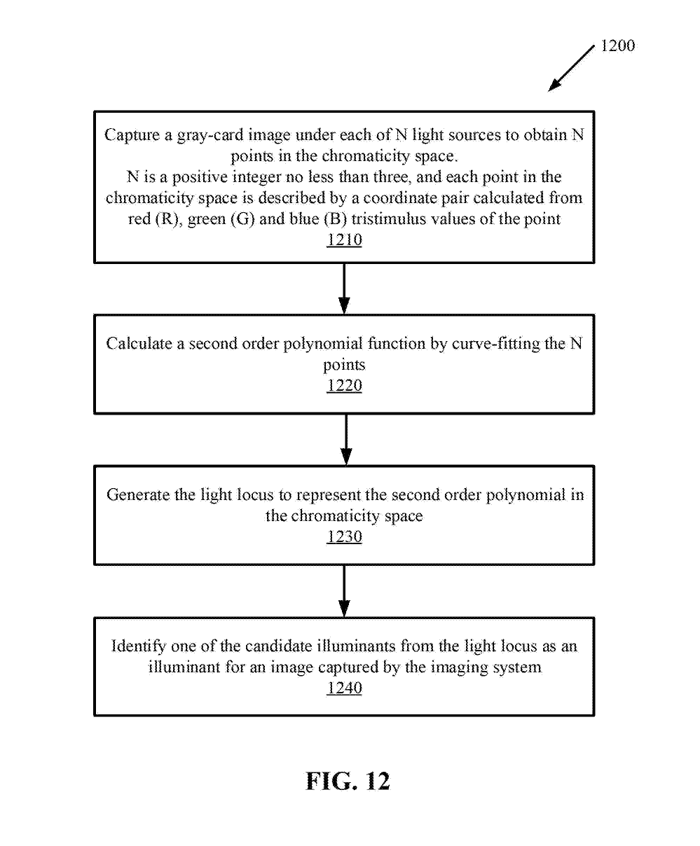

FIG. 12 is a flow diagram illustrating a method 1200 for generating and utilizing a light locus of an imaging system in a chromaticity space of two dimensions according to one embodiment. The light locus represents a collection of candidate illuminants. In one embodiment, the method 1200 may be performed by a device, such as the device 150 of FIG. 1B for providing candidate illuminants to the AWB module 110 of FIG. 1A, the AWB module 300 of FIG. 3, the AWB module 500 of FIG. 5, and/or the AWB module 700 of FIG. 7.

In one embodiment, the method 1200 begins with an imaging system, such as a camera, capturing a gray-card image under each of N light sources to obtain N points in the chromaticity space, wherein N is a positive integer no less than three, and wherein each point in the chromaticity space is described by a coordinate pair calculated from red (R), green (G) and blue (B) tristimulus values of the point (step 1210). The imaging system calculates a second order polynomial function by curve-fitting the N points (step 1220), generates the light locus as a graphical representation of the second order polynomial in the chromaticity space (step 1230), and identifies one of the candidate illuminants from the light locus as an illuminant for an image captured by the imaging system (step 1240).

In the following, efficient methods and systems for generating a color transformation matrix based on chromaticity matching are described according to one embodiment. Color signals generated by one imaging systems may be transformed to corresponding color signals generated by another imaging system using a 3×3 color transformation matrix. In one embodiment, the color transformation matrix may be used in the color correction matrix module (CCM) 120 of FIG. 1A. In one embodiment, the color transformation matrix may be used for transforming a light locus of one imaging system to another light locus of another imaging system.

Conventional chromaticity matching techniques for generating a color transformation matrix typically rely on matching the RGB values of a target camera to the RGB values of a reference camera under the same light source, where the RGB values of a camera is the RGB values of a color checker image taken by the camera. However, these conventional techniques may encounter at least the problems of non-uniform lighting and lens shading. Slight non-uniformity in the lighting and lens shading can cause significant changes in the resulting color transformation matrix. Moreover, shooting an extra image with a uniform gray card at the same spatial location, the same image position, and under the same illumination to correct the color discrepancy between two cameras is quite problematic in the field, where illumination may change between the time instants when the respective images are taken.

The method for generating a color transformation matrix to be described herein is effective for a wide range of different lighting conditions. The method calculates the color transformation matrix in the chromaticity space, in which coordinate values are invariant of: luminance of the set of light sources, non-uniform lighting, exposure errors and lens shading. The method pools together color samples from different images taken by two different cameras to optimize the color transformation matrix, subject to an error metric. The error metric is to minimize the total chromaticity error, which is independent of spatial illumination non-uniformity (i.e., non-uniform lighting) and camera luminance shading (i.e., lens shading). The gradient of this error metric has an analytical expression and, therefore, gradient-based optimization methods can be used to obtain reliable convergence.

In one embodiment, let (x₁,y₁,z₁), (x₂,y₂,z₂), (x₃,y₃,z₃), (x₄,y₄,z₄) be four sets of chromaticity values of a target camera; and let (r₁,g₁,b₁), (r₂,g₂,b₂), (r₃,g₃,b₃), (r₄,g₄,b₄) be their corresponding sets of chromaticity values of a reference camera. Any three sets of these chromaticity values for each camera are not collinear. Let (R,G,B) represents the tristimulus values of the reference camera, and let (X,Y,Z) represents the tristimulus values of the target camera. Let A be the color transformation matrix that maps the tristimulus values (R,G,B) of the reference camera to the corresponding tristimulus values (X,Y,Z) of the target camera. The transformation of tristimulus values from (R,G,B) to (X,Y,Z) is given by

$$[ \begin{matrix}X \\ Y \\ Z\end{matrix} ] = A [ \begin{matrix}R \\ G \\ B\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}R \\ G \\ B\end{matrix} ] \qquad ( 20 )$$

Let x=X/(X+Y+Z), y=Y/(X+Y+Z), z=Z/(X+Y+Z), r=R/(R+G+B), g=G/(R+G+B), and b=B/(R+G+B), equation (20) can be expressed as:

$$[ \begin{matrix}x \\ y \\ z\end{matrix} ] = ( \frac{R + G + B}{X + Y + Z} ) [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}r \\ g \\ b\end{matrix} ] . \qquad ( 21 )$$

Matrix A can be expressed as:

$$A = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] = {c [ \begin{matrix}{x}_{1} & {x}_{2} & {x}_{3} \\ {y}_{1} & {y}_{2} & {y}_{3} \\ {z}_{1} & {z}_{2} & {z}_{3}\end{matrix} ] [ \begin{matrix}\frac{{β}_{1}}{{α}_{1}} & 0 & 0 \\ 0 & \frac{{β}_{2}}{{α}_{2}} & 0 \\ 0 & 0 & \frac{{β}_{3}}{{α}_{3}}\end{matrix} ] [ \begin{matrix}{r}_{1} & {r}_{2} & {r}_{3} \\ {g}_{1} & {g}_{2} & {g}_{3} \\ {b}_{1} & {b}_{2} & {b}_{3}\end{matrix} ]}^{- 1} \\ where [ \begin{matrix}{β}_{1} \\ {β}_{2} \\ {β}_{3}\end{matrix} ] = {[ \begin{matrix}{x}_{1} & {x}_{2} & {x}_{3} \\ {y}_{1} & {y}_{2} & {y}_{3} \\ {z}_{1} & {z}_{2} & {z}_{3}\end{matrix} ]}^{- 1} [ \begin{matrix}{x}_{4} \\ {y}_{4} \\ {z}_{4}\end{matrix} ] , and [ \begin{matrix}{α}_{1} \\ {α}_{2} \\ {α}_{3}\end{matrix} ] = {[ \begin{matrix}{r}_{1} & {r}_{2} & {r}_{3} \\ {g}_{1} & {g}_{2} & {g}_{3} \\ {b}_{1} & {b}_{2} & {b}_{3}\end{matrix} ]}^{- 1} [ \begin{matrix}{r}_{4} \\ {g}_{4} \\ {b}_{4}\end{matrix} ] . \qquad ( 22 )$$

The above calculations can be extended to a general case of four or more sets of chromaticity values for each camera. Let (Uᵢ, Vᵢ), i=1, 2, . . . , N, be N pairs (also referred to as chromaticity pairs) of corresponding chromaticity values between two cameras:

$${V}_{i} = [ \begin{matrix}{x}_{i} \\ {y}_{i} \\ {z}_{i}\end{matrix} ] ; {U}_{i} = [ \begin{matrix}{r}_{i} \\ {g}_{i} \\ {b}_{i}\end{matrix} ]$$

Since matrix A may not be an exact transformation from (R,G,B) to (X,Y,Z), the transformed tristimulus values may be denoted as (X′,Y′,Z′):

$$\begin{matrix}[ \begin{matrix}{X}_{i}^{′} \\ {Y}_{i}^{′} \\ {Z}_{i}^{′}\end{matrix} ] = A [ \begin{matrix}{R}_{i} \\ {G}_{i} \\ {B}_{i}\end{matrix} ] = [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}{R}_{i} \\ {G}_{i} \\ {B}_{i}\end{matrix} ] , and & ( 23 ) \\ [ \begin{matrix}{x}_{i}^{′} \\ {y}_{i}^{′} \\ {z}_{i}^{′}\end{matrix} ] = ( \frac{{R}_{i} + {G}_{i} + {B}_{i}}{{X}_{i}^{′} + {Y}_{i}^{′} + {Z}_{i}^{′}} ) [ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ] [ \begin{matrix}{r}_{i} \\ {g}_{i} \\ {b}_{i}\end{matrix} ] . & ( 24 )\end{matrix}$$

Let P=[1,1,1]^{T}, the expression in (24) can be re-written into the following form:

$$[ \begin{matrix}{x}_{i}^{′} \\ {y}_{i}^{′} \\ {z}_{i}^{′}\end{matrix} ] = ( \frac{{R}_{i} + {G}_{i} + {B}_{i}}{{P}^{T} A [ \begin{matrix}{R}_{i} \\ {G}_{i} \\ {B}_{i}\end{matrix} ]} ) A [ \begin{matrix}{r}_{i} \\ {g}_{i} \\ {b}_{i}\end{matrix} ] = \frac{{AU}_{i}}{{P}^{T} {AU}_{i}} . \qquad ( 25 )$$

Minimize the weighted sum of the square of chromaticity distance E:

$$\begin{matrix}E = {\sum }_{i = 1}^{N} {{w}_{i} ( [ \begin{matrix}{x}_{i } \\ {y}_{i} \\ {z}_{i}\end{matrix} ] - [ \begin{matrix}{x}_{i}^{′} \\ {y}_{i}^{′} \\ {z}_{i}^{′}\end{matrix} ] )}^{T} ( [ \begin{matrix}{x}_{i} \\ {y}_{i} \\ {z}_{i}\end{matrix} ] - [ \begin{matrix}{x}_{i}^{′} \\ {y}_{i}^{′} \\ {z}_{i}^{′}\end{matrix} ] ) \\ = {\sum }_{i = 1}^{N} {{w}_{i} ( {V}_{i} - \frac{{AU}_{i}}{{P}^{T} {AU}_{i}} )}^{T} ( {V}_{i} - \frac{{AU}_{i}}{{P}^{T} {AU}_{i}} ) ,\end{matrix} \qquad ( 26 )$$

where wᵢ is the weight for the chromaticity error of the ith pair. The weights can be chosen to reflect the perceptual errors for different chromaticity pairs.

Take the derivative of E with respect to the matrix A:

$$( 27 )$$

$$\frac{\partial E}{\partial A} = {\sum }_{i = 1}^{N} 2 {w}_{i} [ - \frac{{V}_{i} {U}_{i}^{T}}{{P}^{T} {AU}_{i}} + \frac{{V}_{i}^{T} {AU}_{i}}{{( {P}^{T} {AU}_{i} )}^{2}} {PU}_{i}^{T} + \frac{{AU}_{i} {U}_{i}^{T}}{{( {P}^{T} {AU}_{i} )}^{2}} - \frac{{U}_{i}^{T} {A}^{T} {AU}_{i}}{{( {P}^{T} {AU}_{i} )}^{3}} {PU}_{i}^{T} ]$$

In one embodiment, the steepest descent or the conjugate gradient optimization methods may be applied to (27) to estimate matrix A. It should be noted that matrix A can be determined up to a free scale factor. That is, only eight unknowns in matrix A can be solved. Therefore, in one embodiment a₂₂ is set to one to reduce the number of unknowns to eight because a₂₂ is not likely to be zero.

The color transformation matrix A may be used to convert color signals generated by a reference imaging system to corresponding color signals in a target imaging system, wherein each color signal and the corresponding color signal are generated for or under the same light source. Furthermore, the color transformation matrix A may be used to transform a known light locus of a reference camera C₁ with a target light locus of a target camera C₂. For example, cameras C₁ and C₂ may each take m images under each of n light sources to produce a total of m×n=N chromaticity pairs (Uᵢ,Vᵢ), with the m images being m color block images each having a different color. The set of n light sources may include at least one light source selected from a group including: D65 and Illuminant A according to the CIE standard, and a light source whose spectral distribution approximates a blackbody radiator with a temperature range substantially between 2000 and 2500 degrees K; e.g., 2300 degrees K, such as the light source commonly known as Horizon. A color checker board, such as the Macbeth ColorChecker® may be used to provide the color block images of different colors. As an example, a color checker board may provide m=19 color blocks of different colors, and the n light sources with n=5 may be: D65, TL84 (a.k.a. F11 according to the CIE standard), illuminant A, Horizon, and Cool White Fluorescent (CWF) (a.k.a. F2 according to the CIE standard). Using the 19×5=95 chromaticity pairs, the chromaticity matching matrix A of camera C₁ and camera C₂ can be estimated from equations (23)-(27). Alternatively, a different m and/or a different n may be used.

Under the same light source, the transformation from the reference camera C₁ having (R₁,G₁,B₁) values and the target camera C₂ having corresponding (R₂,G₂,B₂) values can be expressed as:

$$[ \begin{matrix}{R}_{2} \\ {G}_{2} \\ {B}_{2}\end{matrix} ] = A [ \begin{matrix}{R}_{1} \\ {G}_{1} \\ {B}_{1}\end{matrix} ] . \qquad ( 28 )$$

Each point on a light locus can be converted to (r, g, b) values, which are equal to (R,G,B) values multiplied by a scale factor. Thus, matrix A can be used to transform each point on the known light locus of camera C₁ to a corresponding point on the target light locus of camera C₂. The scale factor has no effect on either of the light loci, as each light locus is plotted in the chromaticity space that describes the ratios of the RGB values.

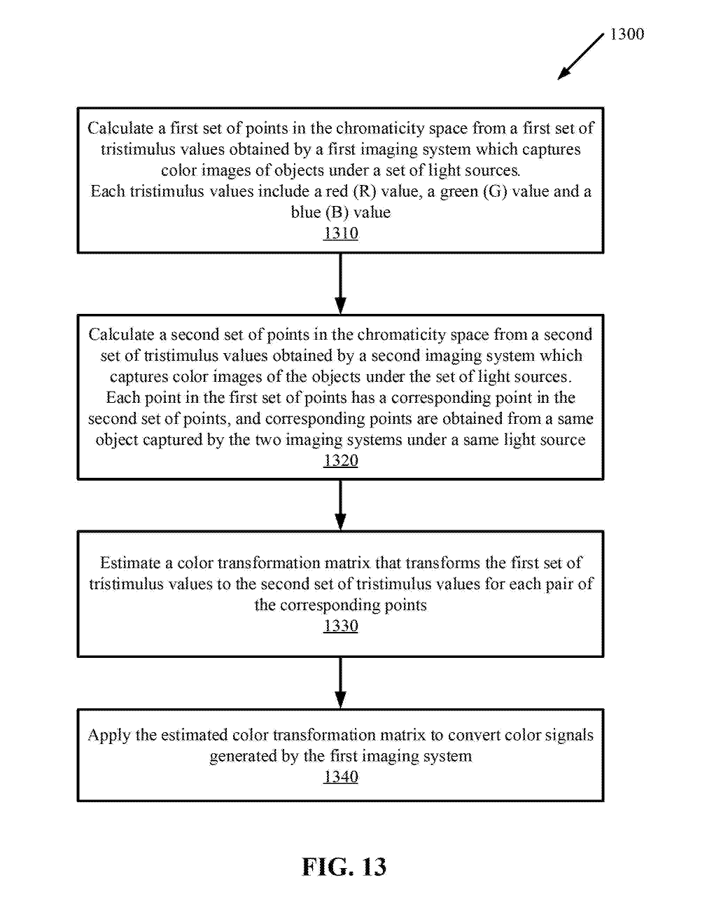

FIG. 13 is a flow diagram illustrating a method 1300 for color transformation between two imaging systems in a chromaticity space of two dimensions according to one embodiment. In one embodiment, the method 1300 may be performed by a device, such as the device 150 of FIG. 1B. In one embodiment, the method 1300 begins with calculating a first set of points in the chromaticity space from a first set of tristimulus values obtained by a first imaging system, which captures color images of objects under a set of light sources, wherein each tristimulus values include a red (R) value, a green (G) value and a blue (B) value (step 1310). A second set of points in the chromaticity space are also calculated from a second set of tristimulus values obtained by a second imaging system, which captures color images of the objects under the set of light sources (step 1320). Each point in the first set of points has a corresponding point in the second set of points, and corresponding points are obtained from a same object captured by the two imaging systems under a same light source. For each pair of the corresponding points, a color transformation matrix that transforms the first set of tristimulus values to the second set of tristimulus values is estimated (step 1330). The estimated color transformation matrix is applied to convert color signals generated by the first imaging system (step 1340).

The operations of the flow diagrams of FIGS. 6, 8, 9, 12 and 13 have been described with reference to the exemplary embodiments of FIGS. 1A, 1B, 3, 5 and 7. However, it should be understood that the operations of the flow diagrams can be performed by embodiments of the invention other than the embodiments discussed with reference to FIGS. 1A, 1B, 3, 5 and 7, and the embodiments discussed with reference to FIGS. 1A, 1B, 3, 5 and 7 can perform operations different than those discussed with reference to the flow diagrams. While the flow diagrams show a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits, or general purpose circuits, which operate under the control of one or more processors and coded instructions), which will typically comprise transistors that are configured in such a way as to control the operation of the circuity in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for generating and utilizing a light locus of an imaging system in a chromaticity space of two dimensions, wherein the light locus represents a collection of candidate illuminants, comprising:
capturing, by the imaging system, a gray-card image under each of N light sources to obtain N points in the chromaticity space, wherein N is a positive integer no less than three, and wherein each point in the chromaticity space is described by a coordinate pair calculated from red (R), green (G) and blue (B) tristimulus values of the point;
calculating a second order polynomial function by curve-fitting the N points;
generating the light locus to represent the second order polynomial in the chromaticity space; and
identifying one of the candidate illuminants from the light locus as an illuminant for an image captured by the imaging system.

2. The method of claim 1, wherein, when N is equal to three, the N light sources are: D65, and Illuminant A according to the International Commission on Illumination (CIE) standard, and a light source whose spectral distribution approximates a blackbody radiator with a temperature range substantially between 2000 and 2500 degrees Kelvin (K).

3. The method of claim 2, further comprising:
calculating an upper bound of the light locus with respect to color temperature in the chromaticity space based on a horizontal coordinate value obtained under the D65 light source.

4. The method of claim 2, further comprising:
calculating a lower bound of the light locus with respect to color temperature in the chromaticity space based on a horizontal coordinate value obtained under the light source whose spectral distribution approximates the blackbody radiator with the temperature range substantially between 2000 and 2500 degrees K.

5. The method of claim 1, wherein after calculating the second order polynomial function, the method further comprises:
capturing, by the imaging system, the gray-card image under one or more additional light sources to obtain one or more additional points in the chromaticity space; and
verifying the light locus by determining whether the one or more additional points lie within a threshold distance from the light locus.

6. The method of claim 5, wherein the one or more additional light sources include one or more of: daylight light sources and tungsten light sources.

7. A method for color transformation between two imaging systems in a chromaticity space of two dimensions, comprising:
calculating a first set of points in the chromaticity space from a first set of tristimulus values obtained by a first imaging system which captures color images of objects under a set of light sources, wherein each tristimulus values include a red (R) value, a green (G) value and a blue (B) value;
calculating a second set of points in the chromaticity space from a second set of tristimulus values obtained by a second imaging system which captures color images of the objects under the set of light sources, wherein each point in the first set of points has a corresponding point in the second set of points, and corresponding points are obtained from a same object captured by the two imaging systems under a same light source;
estimating a color transformation matrix that transforms the first set of tristimulus values to the second set of tristimulus values for each pair of the corresponding points; and
applying the estimated color transformation matrix to convert color signals generated by the first imaging system.

8. The method of claim 7, further comprising:
converting, using the estimated color transformation matrix, a first light locus of the first imaging system to a second light locus of the second imaging system, wherein each of the first light locus and the second light locus represents a collection of candidate illuminants in the chromaticity space; and
identifying one of the candidate illuminants in the second light locus as an illuminant for an image captured by the second imaging system.

9. The method of claim 7, wherein the estimated color transformation matrix is a 3×3 matrix, the method further comprising:
setting one element of the estimated color transformation matrix to a fixed constant; and
calculating the estimated color transformation matrix by minimizing an error metric in the chromaticity space.

10. The method of claim 7, wherein coordinate values in the chromaticity space are invariant of: luminance of the set of light sources, non-uniform lighting, exposure errors and lens shading.

11. The method of claim 7, wherein the set of light sources includes at least one light source selected from a group including: D65 and Illuminant A according to the International Commission on Illumination (CIE) standard, and a light source whose spectral distribution approximates a blackbody radiator with a temperature range substantially between 2000 and 2500 degrees Kelvin (K).

12. A system which generates and utilizes a light locus in a chromaticity space of two dimensions, wherein the light locus represents a collection of candidate illuminants, comprising:
an image sensor to capture a gray-card image under each of N light sources to obtain N points in the chromaticity space, wherein N is a positive integer no less than three, and wherein each point in the chromaticity space is described by a coordinate pair calculated from red (R), green (G) and blue (B) tristimulus values of the point;
a processor coupled to the image sensor, the processor operative to:
calculate a second order polynomial function by curve-fitting the N points;
generate the light locus to represent the second order polynomial in the chromaticity space; and
identify one of the candidate illuminants from the light locus as an illuminant for an image captured by the imaging system.

13. The system of claim 12, wherein, when N is equal to three, the N light sources are: D65, and Illuminant A according to the International Commission on Illumination (CIE) standard, and a light source whose spectral distribution approximates a blackbody radiator with a temperature range substantially between 2000 and 2500 degrees Kelvin (K).

14. The system of claim 13, wherein the processor is further operative to:
calculate an upper bound of the light locus with respect to color temperature in the chromaticity space based on a horizontal coordinate value obtained under the D65 light source.

15. The system of claim 13, wherein the processor is further operative to:
calculate a lower bound of the light locus with respect to color temperature in the chromaticity space based on a horizontal coordinate value obtained under the light source whose spectral distribution approximates the blackbody radiator with the temperature range substantially between 2000 and 2500 degrees K.

16. The system of claim 12, wherein after calculating the second order polynomial function, the processor is further operative to:
verify the light locus by determining whether one or more additional points in the chromaticity space lie within a threshold distance from the light locus, wherein the one or more additional points are obtained from the gray-card image captured under one or more additional light sources.

17. The system of claim 16, wherein the one or more additional light sources include one or more of: daylight light sources and tungsten light sources.

18. A system operative to perform color transformation from a reference system in a chromaticity space of two dimensions, comprising:
an image sensor to capture color images of objects under a set of light sources; and
a processor coupled to the image sensor, the processor operative to:
calculate a target set of points in the chromaticity space from a target set of tristimulus values obtained from the captured color images of the objects under the set of light sources, wherein each tri stimulus values include a red (R) value, a green (G) value and a blue (B) value;
calculate a reference set of points in the chromaticity space from a reference set of tristimulus values obtained by the reference system which captures color images of the objects under the set of light sources,
wherein each point in the reference set of points has a corresponding point in the target set of points, and corresponding points are obtained from a same object captured by the system and the reference system under a same light source;
estimate a color transformation matrix that transforms the reference set of tristimulus values to the target set of tristimulus values for each pair of the corresponding points; and
apply the estimated color transformation matrix to convert color signals generated by the reference system.

19. The system of claim 18, wherein the processor is further operative to:
convert, using the estimated color transformation matrix, a reference light locus of the reference system to a target light locus of the system, wherein each of the reference light locus and the target light locus represents a collection of candidate illuminants in the chromaticity space; and
identify one of the candidate illuminants in the target light locus as an illuminant for an image captured by the system.

20. The system of claim 18, wherein the estimated color transformation matrix is a 3×3 matrix, the processor is further operative to:
set one element of the estimated color transformation matrix to a fixed constant; and
calculate the estimated color transformation matrix by minimizing an error metric in the chromaticity space.

21. The system of claim 18, wherein coordinate values in the chromaticity space are invariant of: luminance of the set of light sources, non-uniform lighting, exposure errors and lens shading.

22. The system of claim 18, wherein the set of light sources includes at least one light source selected from a group including: D65 and Illuminant A according to the International Commission on Illumination (CIE) standard, and a light source whose spectral distribution approximates a blackbody radiator with a temperature range substantially between 2000 and 2500 degrees Kelvin (K).
